(19) United States
(12) Patent Application Publication
(10) Pub. No.: US 2011/0006516 A1
(43) Pub. Date: Jan. 13, 2011

(54) BINDING PIPE BODY AND BINDING METHOD OF PIPE BODY USED OF BRAZING

(76) Inventor: Young Sik Shin, Bucheon Si (KR)

Correspondence Address: CHRISTOPHER PAUL MITCHELL, 888 16TH ST., NW, SUITE 800, WASHINGTON, DC, 20006, US

(21) Appl. No.: 12/599,296

(22) PCT Filed: Sep. 10, 2007
(86) PCT No.: PCT/KR07/04368

§ 371 Date: Nov. 8, 2009

(30) Foreign Application Priority Data
May 8, 2007 (KR) 10-2007-0044608

(51) Int. Cl. F16L 13/02; F16L 9/02; B23K 1/20

(52) U.S. Cl. 285/288.6; 138/109; 228/173.4; 285/288.1

(57) ABSTRACT

A brazed tube assembly and a joining method thereof using brazing, are disclosed. The tube assembly using brazing includes a pre brazed joint assembly method to form a fully pre assembled and locked component prior to brazing. This involves a metal tube with a binding bent portion which is disposed at a lower portion of the basic metal tube bound using brazing to be bent toward an outer periphery, a connecting part to form a binding installation portion with an installation bent portion which is disposed at an upper portion of the connection tube to be bent toward an outer periphery to install the binding basic metal part of the basic metal part, and to form a combining projection upward at an outer end portion of the binding installation portion, and a binding part to form a wetting space at an upper end portion of the binding bent portion of the basic metal part which is in surface contact with the combining projection, wherein filler metal is heated for wetting in a gap between the connecting part and the basic metal part in an installation state to form a filler metal layer which binds the basic metal part and the connecting part.

### TECHNICAL FIELD

The present invention relates to a brazed tube assembly and an assembly method thereof using brazing.

### BACKGROUND ART

Generally, brazing is a joining method by adding a filler metal at a temperature less than the melting point of both parent metals to be brazed, at a temperature of 450° C. or more to allow brazing of the same type or different types of parent metals without damage to the basic metals. Brazing is a widely used joining method in many industries related to vehicles, aircraft, nuclear industry, air conditioning equipment, refrigerators, carbide tools, defense industry components, water fittings, electric and electronic equipment, agricultural implements, domestic appliance and the like.

Brazing Technology advances are one of the reasons for rapid industrial development. Particularly, brazing technology is widely used in the aerospace industry, auto industry, cooling and air conditioning industry, housewares industry, accessories industry and the like for the following advantages.

Firstly, brazing allows the joining of different types of components. Since brazing can be carried out on the same type or different types of metal, the material cost can be reduced and new parts can be developed.

Furthermore, very different components can be joined. Since it facilitates the joining of very different component parts, particularly, products having different sizes and thicknesses, it is possible to reduce the cost of design of the various component parts.

Furthermore, brazing provides a relatively strong joint strength compared to other methods. In the case of brazing ferrous and nonferrous metals, the tensile strength of a brazed joint may be stronger than that of the parent metals. In the case of stainless steel, a brazed joint may have a tensile strength of 130,000 PSI or more.

Furthermore, brazing has its own aesthetic appeal and since a neat joint can be obtained after brazing, there is often no need for further mechanical processing such as eg. grinding or filing.

Furthermore, various characteristics such as cleanability, airtightness, corrosion resistance and the like can be maintained. Since the brazed joint is formed by metallurgical binding, brazing is carried out to offer such advantageous characteristics such as ductility, impact resistance, vibration resistance, airtightness, thermal conductivity, corrosive resistance and the like.

Furthermore, it facilitates both manual operation and automation. Brazing can be performed by a simple hand operation as well as, mass-production using automated brazing and soldering machines, furnaces etc.

Furthermore, the filler metal can be produced in various forms. Materials having various characteristics such as a rod, wire, sheet or strip, preforms or a Brazing Paste can be selected to enable various brazing applications.

With brazing having such various advantages it is a technology for joining both parent metals by applying heat to a filler metal at a temperature almost equal to or less than a melting point of the parent metals to be brazed at a temperature of 450° C. or more without damage to the parent metals. In brazing, a filler metal having a liquidus temperature of 450° C. or more is used and heat corresponding to a solidus temperature of the parent metals or less is applied to effect a brazed joint.

Joining methods using a filler metal are largely classified into welding, brazing or soldering. Generally, welding is an established term; brazing is also called hard soldering; soldering is also called soft soldering.

The principal difference between the three methods is normally accepted as—Soldering is a joining method using a filler metal at a temperature of 450° C. or less, whereas welding and brazing are performed at a temperature of 450° C. or more. However, welding is a joining method performed at a temperature equal to or greater than a melting point of the parent metals to be joined, and brazing is a method of joining both parent metals by applying heat to filler metal at a temperature equal to or less than a melting point without damage to the parent metals.

To explain the principle of the brazing; once a specified temperature is reached, a brazing filler metal melts and flows into and around the joint area of both parent metals to perform an ideal braze.

In this case, an affinity between the parent metals and the filler metal may be represented by wetting. The phenomenon of flow into a joint gap between the parent metals is referred to as a capillary action.

In this case, gravity can also be used. The main principle of brazing can be summarized as—if the parent metals are heated and brazing is performed using a filler metal, the filler metal is melted by both parent metals due to conduction and flows into the joint of both the parent metals due to capillary action.

If wetting of the filler metal on the parent metals is poor, brazing is not properly performed. If the joint gap is large, the filler metal is not fully filling the joint area between the parent metals, thereby creating an incomplete joint.

Particularly, the capillary action is largely dependant on the joint dimensions of the joint to be brazed; ie, when the product is not designed ideally for brazing, brazeability decreases causing cost increases and an increase in failure rate.

Since gravity is a factor in brazing, then gravity should be considered in assembly of the product. Both capillary action and gravity largely influence the flow of the filler metal and wetting is largely related to the affinity of the filler metal

to the parent metals.

Capillary action is a very important physical phenomenon in a brazing process. The fluidity of filler metal depends on a force due to the capillary action, viscosity, density of the melted metal and the configuration of a brazed surface with respect to gravity etc. Generally, viscosity, which can suppress the flow of a filler metal, has a correlation with temperature in the molten state. As the temperature rises, it is known that it influences the viscosity of the molten filler metal. That is, the capillary action provides a very important physical force in that the fluidity of filler metal increases as the temperature increases. As described above, it is closely related to the joint gap dimensions and also closely related to filler metal composition, viscosity, density, the position of surfaces to be brazed with respect to gravity, heating method and the rate of heating.

A conventional formed tube joint assembly to be brazed, in which the heating method and the joint gap are taken into account will be described below.

The brazed tube assembly includes a straight metal pipe (male) 10, and a metal connecting tube (female) 20 to be assembled and joined using brazing. The straight (male) metal tube 10, includes a basic metal tube body 11 and a mating surface 12 at a lower outer portion of the basic metal tube body 11. The connecting metal female tube 20 includes a connecting tube body 21, an enlarged tube part 22 which is formed at an upper portion of the connecting tube body 21 and enlarged to provide a mating surface when the metal mating surface 12 of the metal tube 10 is inserted into the enlarged tube 22, a mating surface 23 formed at the inside of the enlarged tube part 22, a brazing joint space 24 formed between the connecting tube binding surface 23 at the inside of the enlarged tube part 22 and the basic metal binding surface 12 of the basic metal tube body 11, and a filler metal layer 25 formed by melting filler metal and inserting it into the brazing joint space 24 in a state where the basic metal tube body 11 and the connecting tube body 21 are heated.

In the conventional brazed tube assembly, the connecting tube body 21 of the connecting tube 20 which has been enlarged at one end 22, has inserted the basic metal mating surface of the male component 12 formed at a lower outer portion of the metal tube body 11. In this case, the brazing space 24 is formed due to the difference in diameters between enlarged tube part 22 and straight tube 10. In the mated state, the metal tube 10 is heated by a suitable method such that the filler metal is melted to wetting temperature. When the connecting pipe 20 having the enlarged diameter 22 is heated to reach the wetting temperature, the filler metal heated from a heating unit flows into the brazed joint area 24 to form the filler metal layer 25, thereby completing the brazed joint.

However, in the conventional tube assembly using brazing, if the lower item were the male tube 10 and inserted into the female component 20, the molten filler metal in wetting, flows into the joint area 24 due to a capillary action to form the filler metal layer. For this, the basic metal tube 10 and the connecting tube should be maintained at a specified temperature. Accordingly, the basic metal male tube and the connecting female tube, which overlap each other by the enlarged length of the female tube should be additionally heated to have a specified temperature for brazing. A temperature difference caused by heating should be set appropriately for wetting of the filler metal. Thus, the skill of an operator is required, thereby causing problems such as increased labor costs.

Furthermore, in the conventional brazed tube assembly, where the basic metal tube is inserted into the connecting tube with the enlarged tube diameter, the tubes are heated to a temperature suitable for brazing. The basic metal tube and the connecting tube mating area are additionally heated, and the two tubes should be maintained at a proper temperature at which the filler metal is molten and capillary action occurs. However, it is difficult to maintain the precise temperature and should a temperature difference between the two tubes occur, the wetting of the filler metal is often poor and the filler metal is not distributed uniformly in the joint area, thereby causing incomplete filling of the joint area or a lack of wetting of the filler metal to either or both of the joint mating faces.

Furthermore, in the conventional brazed tube assembly, the basic metal tube is inserted into the enlarged tube area formed for brazing. The filler metal is melted into the joint space for flow and wetting of the filler metal. The amount of filler metal for brazing increases and a proper temperature for brazing must be continuously maintained according to the increased amount of filler metal. Accordingly, the material cost increases due to an increase in the amount of filler metal and the heating cost also increases in maintaining the brazing temperature.

Furthermore, in the conventional brazed joint assembly, where the basic metal tube is inserted into the connecting tube with the enlarged tube area, the joint space for wetting of the filler metal between the basic metal tube and the enlarged tube part is formed at a point of a cylindrical tube body. Accordingly, it is difficult to uniformly maintain the brazing space during brazing, and wetting of the filler metal is not accurately performed due to nonuniformity of the brazing space, thereby causing problems of reduced joint strength due to variations in the brazing area.

### DISCLOSURE OF INVENTION

### Technical Problem

Therefore, the present invention has been made in view of the above problems, and it is an objective of the present invention to provide a brazed tube assembly and a joining method thereof using brazing, wherein a brazing area of a basic metal tube is formed to be bent toward an outer periphery and a binding portion of a connecting part is formed to install the bent portion of the basic metal part thereon, thereby improving a binding strength by enlarging a binding area, improving heating efficiency by heating as one body, and improving productivity by performing the binding with a specified strength using a small amount of filler metal in wetting while maintaining a small and specified joint gap.

### Technical Solution

In accordance with an aspect of the present invention, the above and other objectives can be accomplished by the provision of a brazed tube assembly using brazing comprising: a basic metal part to form a binding basic metal part with a binding bent portion which is disposed at a lower portion of the basic metal tube bound using brazing to be bent toward an outer periphery; a connecting part to form a binding installation portion with an installation bent portion which is disposed at an upper portion of the connection tube to be bent toward an outer periphery to install the binding basic metal part of the basic metal part, and to form a combining projection upward at an outer end portion of the binding installation portion; and a binding part to form a wetting space at an upper end portion of the binding bent portion of the basic metal part which is in surface contact with the combining projection, wherein filler metal is heated for wetting in a gap between the connecting part and the basic metal part in an installation state to form a filler metal layer which binds the basic metal part and the connecting part.

Preferably, the basic metal part is configured such that an end binding surface is formed at an end portion of the binding basic metal part, a lower binding surface is formed at a lower portion of the binding basic metal part, a combining binding surface on which the end binding surface of the connecting part is installed is formed at an inside of the combining projection, an installation binding surface is formed at an upper portion of the binding installation portion on which the lower binding surface is installed, and the basic metal part is in surface contact with the connecting part such that the filler metal layer of the binding part is inserted therebetween for binding.

Preferably, the binding part is configured such that the wetting space in which the filler metal is melted in wetting is formed at an upper portion of the binding installation portion of the connecting part on which the end binding surface of the basic metal part is installed, a combining space which communicates with the wetting space is formed between an end portion of the end binding surface and the combining binding surface, an installation space which communicates with the combining space is formed between the lower binding surface of the basic metal part and the installation binding surface, and the melted filler metal flows due to wetting into the installation space through the combining space from the wetting space to form the filler metal layer for binding.

Preferably, the connecting part is configured such that an upper portion of the combining projection is protruded toward an inner periphery to form an anti-separation portion, a preventing binding surface which is in surface contact with the binding basic metal part of the basic metal tube is formed at a lower portion of the anti-separation portion, and the basic metal tube is installed by surface contact to prevent separation.

In accordance with another aspect of the present invention, there is provided a binding method of a pipe body using brazing comprising: forming a basic metal tube, wherein a basic metal part is bent to form a binding bent portion such that a binding basic metal part is formed to include an end binding surface formed at an end portion toward an outer periphery and a lower binding surface formed at a lower portion in a binding portion of the basic metal tube of the basic metal part which is bound using brazing; forming a connection tube, wherein an installation bent portion is formed by bending to form a binding installation portion such that the binding basic metal part formed at the step of forming a basic metal tube is installed at a binding portion of the connection tube of a connecting part, and wherein a combining projection which is bent upward is formed to provide a combining binding surface which is in surface contact with the end binding surface at an outer end portion of the binding installation portion such that an installation binding surface which is in surface contact with the lower binding surface is formed at an installation portion toward an outer periphery, and an anti-separation portion is formed at an upper portion of the combining projection while a preventing binding surface is in surface contact with the binding installation portion; installing the basic metal tube, wherein the binding basic metal part of the basic metal tube is installed on the binding installation portion of the connection tube formed at the step of forming a connection tube such that an installation space is formed at a space where the lower binding surface is in surface contact with the installation binding surface at a lower portion of the basic metal part, a combining space is formed at a space where the end binding surface of the binding basic metal part is in surface contact with the combining binding surface of the combining projection, a wetting space is formed at an upper portion of the end binding surface such that filler metal flows into the combining space due to wetting, and the anti-separation portion with the preventing binding surface in surface contact with the end binding surface is formed at an upper portion of the combining projection such that the basic metal tube is installed at the connection tube; heating as one body, wherein after the basic metal tube is installed at the connection tube in a combined state as one body to prevent separation at the step of installing the basic metal tube, the binding portion of the basic metal tube and the connection tube installed as one body is heated at the same time to a proper binding temperature to allow the filler metal to be in a wetting state; melting the filler metal, wherein after the basic metal tube and the connection tube are heated as one body at the step of heating as one body, the filler metal is melted at a state where the filler metal is positioned at the wetting space and the filler metal is heated for wetting; flowing the filler metal in wetting, wherein after the filler metal is melted at the step of melting the filler metal, the filler metal flows in wetting into the wetting space, the melted filler metal flows in wetting into the installation space through the combining space connected thereto due to a capillary action, the filler metal flows in wetting into the wetting space and the combining space between the preventing binding surface of the connection tube and the end binding surface of the basic metal tube in surface contact with the combining binding surface, and the filler metal flows in wetting into the installation space formed between the lower binding surface of the basic metal tube and the installation binding surface of the connection tube due to a capillary action; and completing binding, wherein after the filler metal flows in wetting into the wetting space of the binding part and the filler metal flows in wetting into the installation space through the combining space due to a capillary action at the step of flowing the filler metal in wetting, the filler metal is solidified to form a filler metal layer, and the joint is completed using brazing in a state where the basic metal tube is installed at the connection tube.

### ADVANTAGEOUS EFFECTS

According to the present invention, there is provided a binding pipe body and a binding method thereof using brazing, wherein a brazing binding portion of a basic metal part is formed to be bent toward an outer periphery and a binding portion of a connecting part is formed to install the bent portion of the basic metal part thereon. Thus, there are effects of improving a binding strength by enlarging a binding area, improving heating efficiency by heating as one body, and improving productivity by performing the binding with a specified strength using a small amount of filler metal in wetting while maintaining a small and specified joint gap.

In the binding pipe body and the binding method thereof using brazing according to the present invention, a binding basic metal part which is bent toward an outer periphery is formed at a lower portion of a basic metal tube of a basic metal part to enlarge a binding area. A combining projection is formed upward at an end portion of a binding installation portion which is bent toward an outer periphery to install the binding basic metal part at an upper portion of a connecting tube connected thereto. At a state where the binding basic metal part which is bent toward an outer periphery formed at a lower portion of the basic metal tube is installed on the binding installation portion with the combining projection of the connecting tube, they are heated as one body at the same time and the filler metal is melted in wetting at a proper temperature for wetting of filler metal, thereby improving wetting efficiency of filler metal and minimizing a binding space. Thus, there are effects of reducing the amount of filler metal, curtailing the material cost, increasing joint strength and improving productivity.

Further, in the binding pipe body and the binding method thereof using brazing according to the present invention, the binding basic metal part has a binding bent portion which is disposed at a lower portion of the basic metal tube bound using brazing to be bent toward an outer periphery. A binding installation portion is formed by forming an installation bent portion which is disposed at an upper portion of the connection tube to be bent toward an outer periphery according the shape of the binding basic metal part. The combining projection protruded upward is formed at an end portion of the binding installation portion. Accordingly, a lower portion of the basic metal part is installed while supporting the outside by the combining projection. An anti-separation portion is formed at an upper portion of the combining projection to be protruded inward. The basic metal part is installed on and combined to the connecting part as one body to prevent separation and they are heated as one body. Thus, there are effects of increasing operation efficiency, preventing separation, improving assembling efficiency, and increasing a binding strength.

Further, in the binding pipe body and the binding method thereof using brazing according to the present invention, a wetting space is formed on the preventing binding surface of the anti-separation portion in surface contact with an upper portion of the end binding surface form at an end portion of the binding basic metal part of the basic metal part. The combining projection is formed to have a combining binding surface to form a combining space by surface contact at the outside of the end binding surface. The installation binding surface is formed at an upper portion of the binding installation portion to be in surface contact with the lower binding surface at a lower portion of the binding basic metal part, thereby forming an installation space. The basic metal tube is installed at and combined to the connecting tube such that the wetting space for wetting of filler meal, the combining space and the installation space have a specified gap, thereby maintaining a specified gap in a filler metal binding space in the installation. Thus, there is an effect of improving a binding strength of brazing.

Further, in the binding pipe body and the binding method thereof using brazing according to the present invention, the binding basic metal part is formed by bending a lower portion of the basic metal part toward an outer periphery. The binding installation portion is formed at an upper portion of the connecting tube to be bent in shape for installing the binding basic metal part. The combining projection is formed upward at an outer end portion of the binding installation portion. The anti-separation portion for preventing separation is formed at an upper portion of the combining projection. The basic metal tube is installed at the connecting tube by combing them at the outside. At a state where the basic metal tube is installed at and combined to the connecting tube as one body, the brazing operation is performed. The two tubes are heated as one body to a proper brazing temperature without separately heating the two tubes, thereby improving the heating efficiency. Since they are heated as one body at the same time, the brazing operation can be performed without skillfulness of the operator, thereby improving productivity.

Further, in the binding pipe body and the joining method thereof using brazing according to the present invention, the end binding surface provided at an end portion of the binding basic metal part which is bent outward at a lower portion of the basic metal part is formed such that the preventing binding surface of the anti-separation portion of the connecting tube is in surface contact with the combining binding surface of the combining projection. The wetting space and the combining space are formed, and the installation space for wetting of filler metal is formed on the installation binding surface of the binding installation portion in surface contact with the lower binding surface formed at a lower portion of the binding basic metal part. The filler metal flows in wetting into a bent and outer space for binding. There are effects of minimizing a wetting space of filler metal and improving a binding strength by performing the binding at a bent portion.

Further, in the binding pipe body and the binding method thereof using brazing according to the present invention, the binding basic metal part is formed to form the binding bent portion which is bent toward an outer periphery at a lower portion of the basic metal tube for brazing binding. The binding installation portion is formed at an upper portion of the connecting tube to install the binding basic metal part. A preventing projection for preventing separation toward the outside and side portions is formed at the outside of the binding installation portion. The anti-separation portion is formed at an upper portion of the preventing projection to prevent separation toward an upper portion. The tubes are heated in a combined state and filler metal is melted into a binding portion of the basic metal tube and the connecting tube. The filler metal is solidified in wetting to form the binding filler metal layer. Accordingly, when they are heated as one body in an installation and combining state to a wetting temperature of the filler metal, the filler metal is melted and flows into an inner space due to a capillary action to perform the binding. Thus, there are effects of reducing the steps of the binding process and facilitating the operation.

Further, in the binding pipe body and the joining method thereof using brazing according to the present invention, a lower portion of the basic metal tube which is joined using brazing is bent toward an outer periphery. Then, the basic metal tube is installed at and combined to the connecting tube to prevent separation toward side and upper portions. In this state, the filler metal is melted to perform the brazing by heating them as one body, thereby minimizing the reduction of wetting efficiency of the filler metal due to a temperature difference. After installation and combination, the filler metal is injected into the bent portion while maintaining a specified wetting gap of the filler metal. Accordingly, the lower, side and upper portions of the basic metal tube are bound at the same time. Thus, there is an effect of improving a binding strength by distributing the load although a couple of forces are generated due to an external force.

Further, in the binding pipe body and the binding method thereof using brazing according to the present invention, a lower portion of the basic metal tube which is bound using brazing is bent and the basic metal tube is installed at and combined to the connecting tube to prevent separation toward side and upper portions. In this state, the filler metal is melted to perform the binding in wetting due to a capillary action, thereby reducing the amount of filler metal while maintaining a binding strength. Also, it is possible to reduce a heating amount consumed due to heating of filler metal according to the reduction in the amount of filler metal. Since they are heated and combined as one body, the skillfulness of an operator is not required, thereby reducing the production cost and improving productivity.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a cross-sectional view of a conventional binding pipe body using brazing;

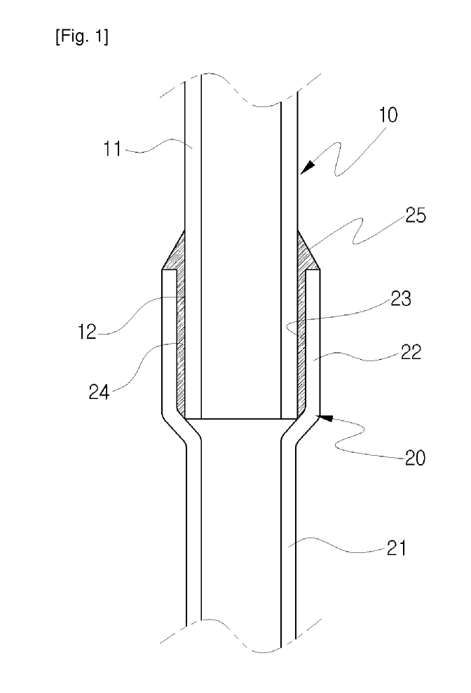

FIG. 2 illustrates a perspective view of a binding pipe body using brazing according to the present invention;

FIG. 3 illustrates an exploded perspective view of the binding pipe body using brazing according to the present invention;

FIG. 4 illustrates a cross-sectional view of the binding pipe body using brazing according to the present invention;

FIG. 5 illustrates a configuration diagram of the binding pipe body using brazing before installation according to the present invention;

FIG. 6 illustrates a configuration diagram of the binding pipe body using brazing in a heated state after installation according to the present invention;

FIG. 7 illustrates a configuration diagram of the binding pipe body using brazing in a binding state using filler metal in wetting according to the present invention; and

FIG. 8 illustrates a flowchart showing a binding method of a pipe body using brazing according to the present invention.

### BEST MODE FOR CARRYING OUT THE INVENTION

Hereinafter, a binding pipe body and a binding method of a pipe body using brazing according to the present invention will be described in detail with reference to the accompanying drawings.

First, it is noted that the same components or parts are designated by the same reference numerals as much as possible in the drawings. In the description of the present invention, the detailed description of related well-known function or configuration is omitted to prevent the point of the invention from being ambiguous.

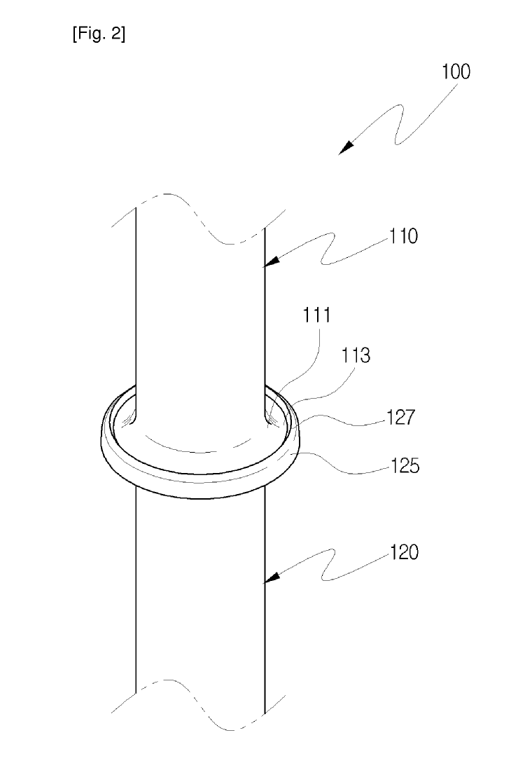

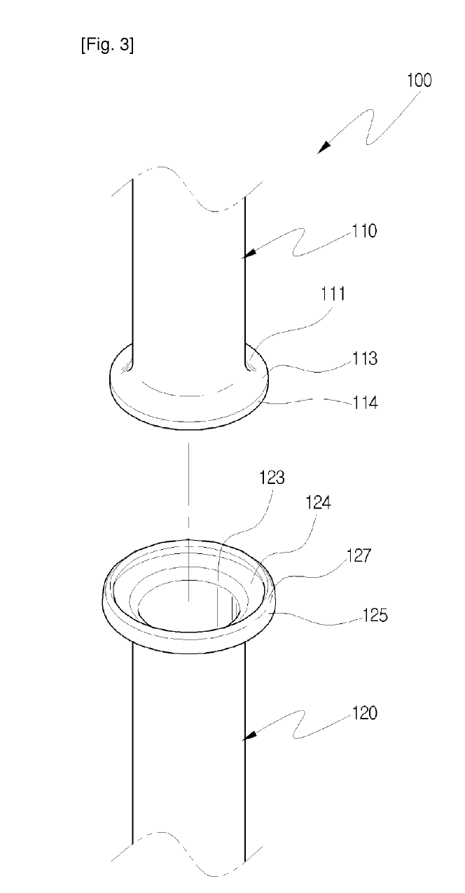

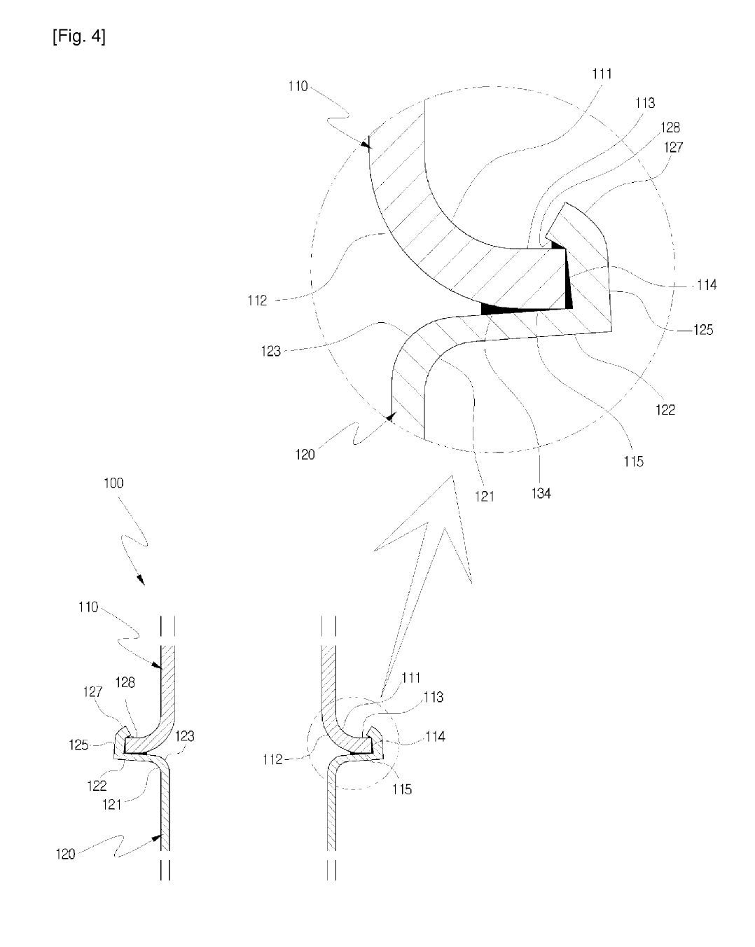

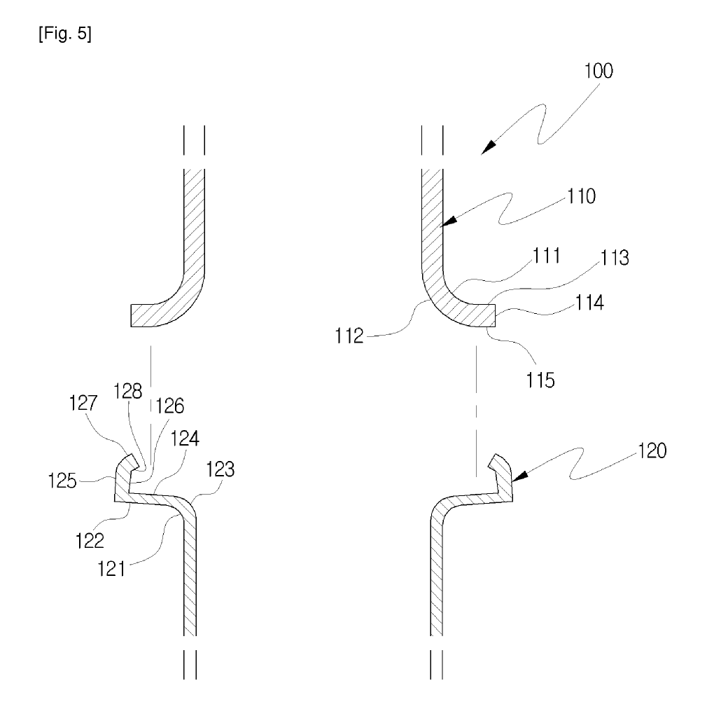

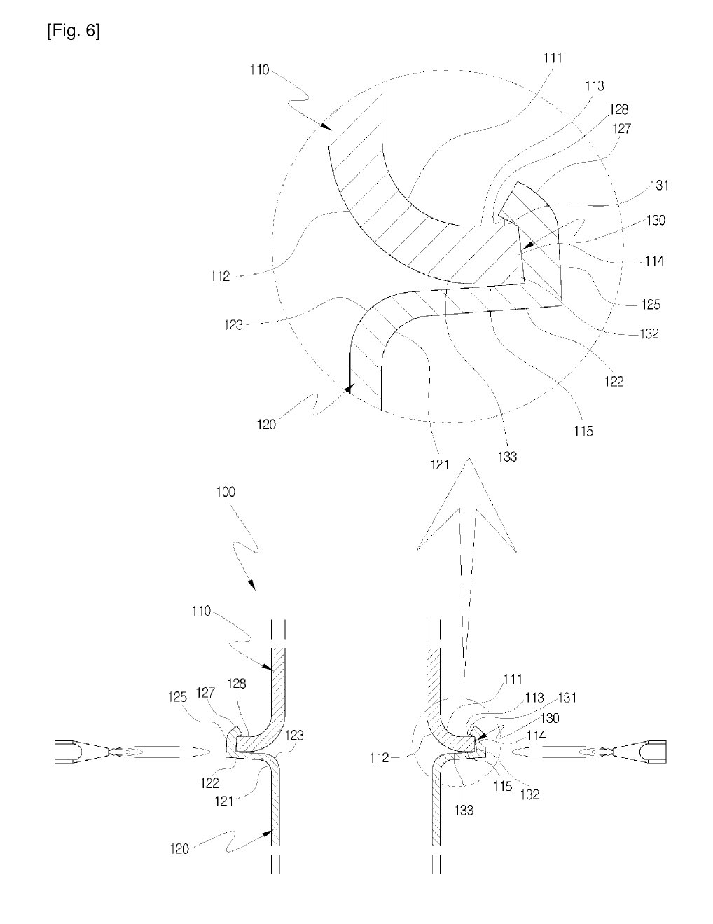

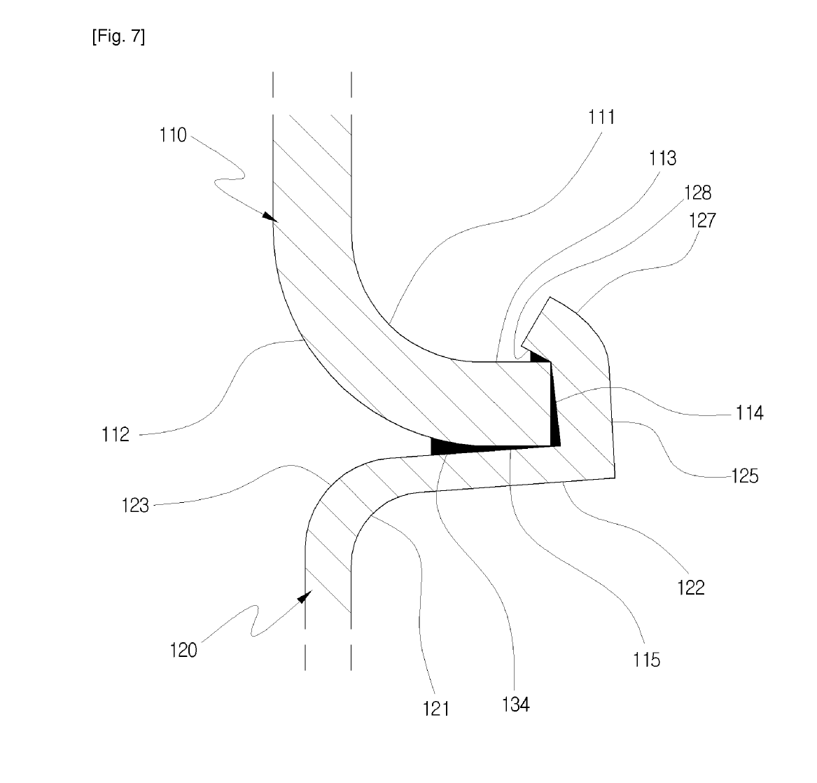

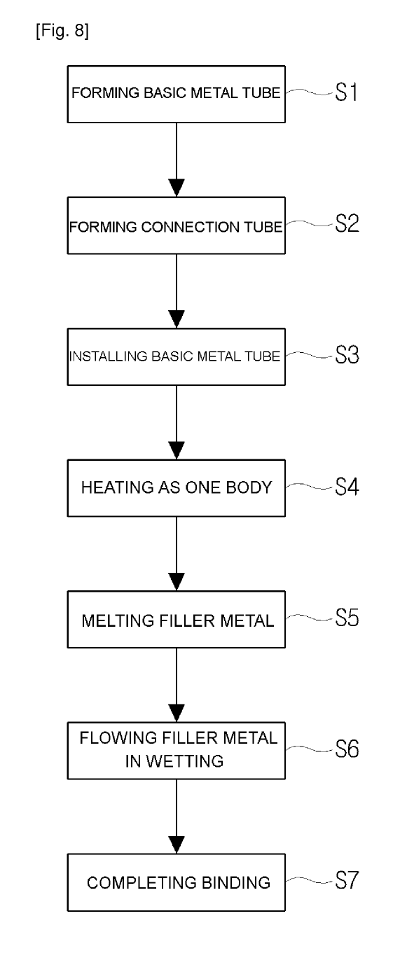

FIG. 2 illustrates a perspective view of a binding pipe body using brazing according to the present invention. FIG. 3 illustrates an exploded perspective view of the binding pipe body using brazing according to the present invention. FIG. 4 illustrates a cross-sectional view of the binding pipe body using brazing according to the present invention. FIG. 5 illustrates a configuration diagram of the binding pipe body using brazing before installation according to the present invention. FIG. 6 illustrates a configuration diagram of the binding pipe body using brazing in a heated state after installation according to the present invention. FIG. 7 illustrates a configuration diagram of the binding pipe body using brazing in a binding state using filler metal in wetting according to the present invention. FIG. 8 illustrates a flowchart showing a binding method of a pipe body using brazing according to the present invention.

As shown in FIGS. 2 to 8, a binding pipe body 100 using brazing according to the present invention includes a basic metal part 110 with a basic metal tube 111 which is bound using brazing, a connecting part 120 with a connection tube 121 which is connected to a lower portion of the basic metal tube 111 of the basic metal part 110, and a binding part 130 which is bound between the basic metal tube 111 of the basic metal part 110 and the connection tube 121 of the connecting part 120 by a filler metal layer 134.

The basic metal part 110 is configured to form a binding basic metal part 110 with a binding bent portion 112 which is disposed at a lower portion of the basic metal tube 111 bound using brazing to be bent toward an outer periphery.

The connecting part 120 is configured to form a binding installation portion 122 with an installation bent portion 123 which is disposed at an upper portion of the connection tube 121 to be bent toward an outer periphery to install the binding basic metal part 110 of the basic metal part 110. Also, the connecting part 120 is configured to form a combining projection 125 upward at an outer end portion of the binding installation portion 122.

In the basic metal part 110, an end binding surface 114 is formed at an end portion of the binding basic metal part 110 and a lower binding surface 115 is formed at a lower portion of the binding basic metal part 110. A combining binding surface 126 on which the end binding surface 114 of the connecting part 120 is installed is formed at the inside of the combining projection 125. An installation binding surface 124 is formed at an upper portion of the binding installation portion 122 on which the lower binding surface 115 is installed. The basic metal part 110 is in surface contact with the connecting part 120 such that the filler metal layer 134 of the binding part 130 is inserted therebetween for binding.

Further, in the connecting part 120, an upper portion of the combining projection 125 is protruded toward an inner periphery to form an anti-separation portion 127. A preventing binding surface 128 which is in surface contact with the binding basic metal part 110 of the basic metal tube 111 is formed at a lower portion of the anti-separation portion 127. The basic metal tube 111 is installed by surface contact to prevent separation.

In the binding part 130, a wetting space 131 is formed at an upper end portion of the binding bent portion 112 of the basic metal part 110 which is in surface contact with the combining projection 125. The filler metal is heated for wetting in a gap between the connecting part 120 and the basic metal part 110 in an installation state to form the filler metal layer 134 which binds the basic metal part 110 and the connecting part 120.

In this case, in the binding part 130, the wetting space 131 in which the filler metal is melted in wetting is formed at an upper portion of the binding installation portion 122 of the connecting part 120 on which the end binding surface 114 of the basic metal part 110 is installed. A combining space 132 which communicates with the wetting space 131 is formed between an end portion of the end binding surface 114 and the combining binding surface 126. An installation space 133 which communicates with the combining space 132 is formed between the lower binding surface 115 of the basic metal part 110 and the installation binding surface 124. The melted filler metal flows due to wetting into the installation space 133 through the combining space 132 from the wetting space 131 to form the filler metal layer 134 for binding.

Hereinafter, the action of the above-configured binding pipe body using brazing will be described through a binding method.

First, at step S1 of forming a basic metal tube, in a binding portion of the basic metal tube 111 of the basic metal part 110 which is bound using brazing, the binding basic metal part 110 is formed to include the end binding surface 114 formed at an end portion toward an outer periphery and the lower binding surface 115 formed at a lower portion. For this, the basic metal part 110 is bent to form the binding bent portion 112 and the binding basic metal part 110 is bent and formed at the basic metal tube 111.

Then, the binding basic metal part 110 formed at step S1 of forming a basic metal tube is installed at a binding portion of the connection tube 121 of the connecting part 120. For this, at step S2 of forming a connection tube, the installation bent portion 123 is formed by bending to form the binding installation portion 122, thereby providing the installation binding surface 124 which is in surface contact with the lower binding surface 115 at an installation portion toward an outer periphery. The combining projection 125 which is bent upward is formed to provide the combining binding surface 126 which is in surface contact with the end binding surface 114 at an outer end portion of the binding installation portion 122. The anti-separation portion 127 is formed at an upper portion of the combining projection 125 such that the preventing binding surface 128 is in surface contact with the binding installation portion 122. That is, at step S2, the connection tube 121 is formed such that the basic metal tube 111 is installed thereon.

Then, at step S3 of installing a basic metal tube, the binding basic metal part 110 of the basic metal tube 111 is installed on the binding installation portion 122 of the connection tube 121 formed at step S2 of forming a connection tube. In this case, the installation space 133 is formed at a space where the lower binding surface 115 is in surface contact with the installation binding surface 124 at a lower portion of the basic metal part 110. The combining space 132 is formed at a space where the end binding surface 114 of the binding basic metal part 110 is in surface contact with the combining binding surface 126 of the combining projection 125. The wetting space 131 is formed at an upper portion of the end binding surface 114 such that the filler metal flows into the combining space 132 due to wetting. The anti-separation portion 127 with the preventing binding surface 128 in surface contact with the end binding surface 114 is formed at an upper portion of the combining projection 125. That is, at step S3, the basic metal tube 111 is installed at the connection tube 121 to prevent separation toward the side and upper portions.

Then, after the basic metal tube 111 is installed at the connection tube 121 in a combined state as one body to prevent separation at step S3 of installing a basic metal tube, step S4 of heating as one body is performed to form the filler metal in wetting. For this, a binding portion of the basic metal tube 111 and the connection tube 121 installed as one body is heated at the same time to a proper binding temperature. That is, at step S4, the binding portion of the connection tube 121 on which the basic metal tube 111 is installed is heated as one body.

After the basic metal tube 111 and the connection tube 121 are heated as one body at step S4 of heating as one body, step S5 of melting filler metal is performed to melt the filler metal. At a state where the filler metal is positioned at the wetting space 131, the filler metal is heated for wetting. That is, at step S5, the filler metal is melted at the binding portion of the basic metal tube 111 and the connection tube 121.

After the filler metal is melted at step S5 of melting a filler metal, step S6 of flowing filler metal in wetting is performed. The filler metal flows in wetting into the wetting space 131 and then, the melted filler metal flows in wetting into the installation space 133 through the combining space 132 connected thereto due to a capillary action. The filler metal flows in wetting into the wetting space 131 and the combining space between the preventing binding surface 128 of the connection tube 121 and the end binding surface of the basic metal tube in surface contact with the combining binding surface 126. The filler metal flows in wetting into the installation space 133 formed between the lower binding surface 115 of the basic metal tube 111 and the installation binding surface 124 of the connection tube due to a capillary action. That is, at step S6, the filler metal flows in wetting into the binding part 130 formed in a binding portion of the basic metal tube 111 and the connection tube 121.

After the filler metal flows in wetting into the wetting space 131 of the binding part 130 and the filler metal flows in wetting into the installation space 133 through the combining space 132 due to a capillary action at step S6 of flowing the filler metal in wetting, step S7 of completing binding is performed. The filler metal is solidified to form the filler metal layer 134. The binding is completed using brazing in a state where the basic metal tube 111 is installed at the connection tube 121. That is, at step S7, the filler metal layer 134 of the binding part 130 is solidified in wetting at the binding portion of the basic metal tube 111 and the connection tube 121 to complete the binding.

Thus, the binding basic metal part 110 is formed to be bent toward an outer periphery to form the binding bent portion 112 at a lower portion of the basic metal part 110 bound using brazing. The binding installation portion 122 is formed at an upper portion of the connecting part 120 to install the binding basic metal part 110. The combining projection 125 is formed at the outside of the binding installation portion 122 to support the outside of the binding basic metal part 110. The anti-separation portion 127 is formed at an upper portion of the combining projection 125 to prevent separation of the binding basic metal part 110. Accordingly, the basic metal tube 111 is supported by and combined to the connection tube 121 to prevent separation toward the outside and upper portions. Consequently, the filler metal flows in wetting while a specified gap of a filler metal wetting space is maintained at the binding part 130 of binding the basic metal tube 111 and the connection tube 121 and the outside and upper portions to be bound are supported, thereby improving a binding strength and reducing the cost of raw materials due to a decrease in the melted amount of filler metal. Further, since the basic metal tube 111 and the connection tube 121 are installed as one body and heated at the same time, wetting efficiency of the filler metal according to heating is improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A binding pipe body using brazing comprising:
a basic metal part to form a binding basic metal part with a binding bent portion which is disposed at a lower portion of the basic metal tube bound using brazing to be bent toward an outer periphery;
a connecting part to form a binding installation portion with an installation bent portion which is disposed at an upper portion of the connection tube to be bent toward an outer periphery to install the binding basic metal part of the basic metal part, and to form a combining projection upward at an outer end portion of the binding installation portion; and
a binding part to form a wetting space at an upper end portion of the binding bent portion of the basic metal part which is in surface contact with the combining projection, wherein filler metal is heated for wetting in a gap between the connecting part and the basic metal part in an installation state to form a filler metal layer which binds the basic metal part and the connecting part.

2. The binding pipe body according to claim 1, wherein the basic metal part is configured such that an end binding surface is formed at an end portion of the binding basic metal part, a lower binding surface is formed at a lower portion of the binding basic metal part, a combining binding surface on which the end binding surface of the connecting part is installed is formed at an inside of the combining projection, an installation binding surface is formed at an upper portion of the binding installation portion on which the lower binding surface is installed, and the basic metal part is in surface contact with the connecting part such that the filler metal layer of the binding part is inserted there between for binding.

3. The binding pipe body according to claim 1, wherein the binding part is configured such that the wetting space in which the filler metal is melted in wetting is formed at an upper portion of the binding installation portion of the connecting part on which the end binding surface of the basic metal part is installed, a combining space which communicates with the wetting space is formed between an end portion of the end binding surface and the combining binding surface, an installation space which communicates with the combining space is formed between the lower binding surface of the basic metal part and the installation binding surface, and the melted filler metal flows due to wetting into the installation space through the combining space from the wetting space to form the filler metal layer for binding.

4. The binding pipe body according to claim 1, wherein the connecting part is configured such that an upper portion of the combining projection is protruded toward an inner periphery to form an anti-separation portion, a preventing binding surface which is in surface contact with the binding basic metal part of the basic metal tube is formed at a lower portion of the anti-separation portion, and the basic metal tube is installed by surface contact to prevent separation.

5. A binding method of a pipe body using brazing comprising:
forming a basic metal tube, wherein a basic metal part is bent to form a binding bent portion such that a binding basic metal part is formed to include an end binding surface formed at an end portion toward an outer periphery and a lower binding surface formed at a lower portion in a binding portion of the basic metal tube of the basic metal part which is bound using brazing;
forming a connection tube, wherein an installation bent portion is formed by bending to form a binding installation portion such that the binding basic metal part formed at the step of forming a basic metal tube is installed at a binding portion of the connection tube of a connecting part, and wherein a combining projection which is bent upward is formed to provide a combining binding surface which is in surface contact with the end binding surface at an outer end portion of the binding installation portion such that an installation binding surface which is in surface contact with the lower binding surface is formed at an installation portion toward an outer periphery, and an anti-separation portion is formed at an upper portion of the combining projection while a preventing binding surface is in surface contact with the binding installation portion;
installing the basic metal tube, wherein the binding basic metal part of the basic metal tube is installed on the binding installation portion of the connection tube formed at the step of forming a connection tube such that an installation space is formed at a space where the lower binding surface is in surface contact with the installation binding surface at a lower portion of the basic metal part, a combining space is formed at a space where the end binding surface of the binding basic metal part is in surface contact with the combining binding surface of the combining projection, a wetting space is formed at an upper portion of the end binding surface such that filler metal flows into the combining space due to wetting, and the anti-separation portion with the preventing binding surface in surface contact with the end binding surface is formed at an upper portion of the combining projection such that the basic metal tube is installed at the connection tube;
heating as one body, wherein after the basic metal tube is installed at the connection tube in a combined state as one body to prevent separation at the step of installing the basic metal tube, the binding portion of the basic metal tube and the connection tube installed as one body is heated at the same time to a proper binding temperature to allow the filler metal to be in a wetting state;
melting the filler metal, wherein after the basic metal tube and the connection tube are heated as one body at the step of heating as one body, the filler metal is melted at a state where the tiller metal is positioned at the wetting space and the filler metal is heated for wetting;
flowing the filler metal in wetting, wherein after the filler metal is melted at the step of melting the filler metal, the filler metal flows in wetting into the wetting space, the melted filler metal flows in wetting into the installation space through the combining space connected thereto due to a capillary action, the filler metal flows in wetting into the wetting space and the combining space between the preventing binding surface of the connection tube and the end binding surface of the basic metal tube in surface contact with the combining binding surface, and the filler metal flows in wetting into the installation space formed between the lower binding surface of the basic metal tube and the installation binding surface of the connection tube due to a capillary action; and
completing binding, wherein after the filler metal flows in wetting into the wetting space of the binding part and the filler metal flows in wetting into the installation space through the combining space due to a capillary action at the step of flowing the filler metal in wetting, the filler metal is solidified to form a filler metal layer, and the binding is completed using brazing in a state where the basic metal tube is installed at the connection tube.
